(19) United States
(12) Patent Application Publication
(10) Pub. No.: US 2003/0035233 A1
(43) Pub. Date: Feb. 20, 2003

(54) Disk drive odometer

(76) Inventor: Reza Jalili, Bronxville, NY (US)

Correspondence Address: Reza Jalili, 1 Vincent Rd. #3-0, Bronxville, NY, 10708, US

(21) Appl. No.: 09/932,736

(22) Filed: Aug. 17, 2001

(51) Int. Cl. G11B 27/36; G11B 5/02

(52) U.S. Cl. 360/31; 360/55

(57) ABSTRACT

If a computer disk drive is stolen and later recovered, there is no way currently to know if the disk was accessed. The present invention offers a solution to the problem of detecting disk access and provides means for implementing quota and usage restrictions as well as detection schemes. The present invention teaches to use a one-way counter which counts the number of bytes written to and read from the drive. The counter itself can only be read. Operating system software can make use of the counter to provide access control and access detection.

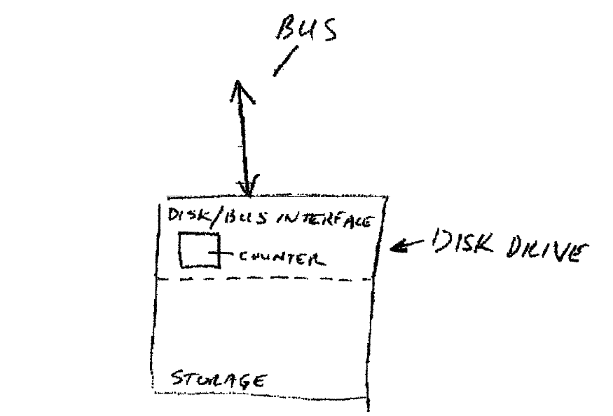

### BACKGROUND OF THE INVENTION

The present invention relates to a device associated with a hard disk drive for improving data security by keeping a history of reads and writes to and from the drive.

There is a need for purposes of data security to track the reading and writing activity that has occurred for a given hard disk drive or other storage device. For example, if a drive has been stolen there is a need after the drive has been recovered to know whether the data on the drive was accessed by the thief. Further, there is a need to monitor read and write activity on a routine basis, to determine whether any unauthorized activity (such as theft, destruction or modification of data) has taken place.

Circuits are known in the data communications field, for example a circuit on a known Ethernet card, for tracking a number of bytes sent and received over a network. Such circuits may be used for purposes of billing and for enforcing compliance with licensing limitations. In view of this state of the art, those skilled in the pertinent art will appreciate that circuits are available and/or can be developed for carrying out the novel purposes and functions described herein.

### SUMMARY OF THE INVENTION

To address these needs, the invention provides a disk odometer which comprises a circuit associated with a given disk drive, or any compatible storage device, for tracking the number of bytes that have been read to or from the disk over a given period of time.

In this context, the term “disk” should be understood to include any mass storage device that is capable of having a device according to this invention built into or added onto it. This includes any fixed or removable disk, but also a flash memory card or any other device that can support an attached circuit for carrying out the functions described herein.

Conventionally, disk circuitry has a read/write buffer which exchanges data with the disk/bus interface. According to an embodiment of the invention, the odometer device may be an additional circuit, namely a counter that is automatically incremented upon each data exchange. For simplicity, the counter may count up only. The counter may be incremented for every disk access, whether read or write. Alternatively, there may be two counters, one for reads and one for writes.

Advantageously, but not necessarily, the counter is never decremented under any conditions, to avoid the risk that an unauthorized disk access could be concealed by manipulating operating conditions of the disk to reduce the counter reading to an original value.

Likewise, the counter advantageously, but not necessarily, does not reset upon overflow, again to avoid the possibility that an unauthorized disk access could be concealed by a reset of the counter.

The memory in the disk odometer is advantageously a read-only memory, and is accessible at only a single interface and via pins, for example, which permit readout only, in order to prevent or discourage tampering with the odometer.

Optionally, after being checked, the odometer can be either manually or automatically reset by an authorized person to zero or another value.

Optionally, sector, cylinder, and/or head information pertaining to the reads and writes can be stored as well.

According to another embodiment of the invention, the odometer may store time information and indicate the date and time at which the disk accesses occurred.

Other features and advantages of the present invention will become apparent from the following description of the invention which refers to the accompanying drawings.

### BRIEF DESCRIPTION OF THE DRAWING(S)

The FIGURE is a schematic block diagram showing one embodiment of the invention.

### DETAILED DESCRIPTION OF EMBODIMENTS OF THE INVENTION

The FIGURE shows one embodiment of the invention. Data pass in both directions between the system bus and the disk drive via the disk/bus interface. The disk/bus interface is built inseparably into the physical disk drive. Included in the disk/bus interface is a counter which increments for each byte of data which passes into or out of the disk drive.

A reading circuit is provided on the motherboard of the computer for accessing the current value stored in the counter.

A routine is included in the operating system (OS) software for displaying the counter value. Further, even when there is no suspicion of a security breach, the OS can implement regular readings of the counter according to a predetermined schedule, and/or implement a locking function. According to the locking function, the counter value is constantly or periodically monitored and an alarm is issued if its value changes, which would indicate an unauthorized disk access.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A disk drive odometer substantially as shown and described.

2. A data storage device comprising:
a mass storage device;
a circuit associated with said mass storage which generates data representative of data inputs and outputs of said mass storage device.

3. A data storage device as in claim 1, wherein said mass storage device is portable and said circuit is physically attached to said mass storage device for being portable therewith.

4. A data storage device as in claim 3, wherein said mass storage device is a hard disk drive.

5. A data storage device as in claim 1, wherein said circuit comprises a counter which indicates a cumulative quantity of data input to and output from said mass storage device.

6. A data storage device as in claim 5, wherein in response to said data inputs and outputs, said counter automatically increments.

7. A data storage device as in claim 6, wherein said counter does not decrement or reset in response to said data inputs and outputs.

8. A method of providing a mass storage device with improved data security, substantially as shown and described.

9. A method of detecting unauthorized accesses to a mass storage device, substantially as shown and described.

10. A method of measuring data transfer on a mass storage device, comprising the steps of:
reading information indicating a first amount of data that has been written to and read from said mass storage device as of a first point in time;
reading information indicating a second amount of data that has been written to and read from said mass storage device as of a second point in time;
determining whether there is a difference between said first and second amounts, and if so, comparing said difference to an authorized difference so as to determine whether such difference is authorized or unauthorized.

11. A method as in claim 10, wherein said second amount is generated by counting units of data that are read from or written to said mass storage device after said first point in time.
